(19) United States
(12) Patent Application Publication
(10) Pub. No.: US 2006/0083402 A1
(43) Pub. Date: Apr. 20, 2006

(54) Angled cone of loudspeaker

(76) Inventor: Hiroshi Ohara, Tao-Yuan Hsien (TW)

Correspondence Address: BACON & THOMAS, PLLC, 625 SLATERS LANE, FOURTH FLOOR, ALEXANDRIA, VA, 22314, US

(21) Appl. No.: 10/968,142

(22) Filed: Oct. 20, 2004

(51) Int. Cl. H04R 1/00; H04R 9/06; H04R 11/02

(52) U.S. Cl. 381/429; 381/423; 381/424

(57) ABSTRACT

An angled cone of loudspeaker is pressed with heat to form a polygonal cone body, in which a plurality of turning points is arranged radially while a deflective line is disposed annually to thereby maintain the proper elasticity and the strength of the cone.

### BACKGROUND OF THE INVENTION

1. Field of the Invention

The present invention relates to a voice-generating acoustic device applied in loudspeakers for displacing air.

2. The Prior Arts

FIG. 1 shows a typical conventional dynamic structure of loudspeaker, comprising a motive power system, a cone, and a suspension system, in which the motive power system further comprises a magnet A, an electrode piece B, an upper iron C, and a voice coil E. The cone, which is substantially a diaphragm F for displacing air, is usually formed as a conic or semi-spherical acoustic bowl, and the suspension system, which is comprised of a damper G and a suspension edge thereof, is provided for damping the diaphragm F moving in a specified direction.

The working principle of the dynamic loudspeaker is that an electromagnetic field is generated in a direction perpendicular to the magnetic field induced by a permanent magnet of the loudspeaker when a current flows through a voice coil of the loudspeaker such that a movable coil is activated to move within the gap D (a clearance between the voice coil and the magnet) that enables the diaphragm attached on the voice coil to vibrate up and down and sound to play the roll of a transducer for converting electric energy into sound.

As shown in FIG. 2, the structure of a conventional cone is commonly formed of cloth, paper, rubber, or even metal and perforated a hole A1 in center for mounting a voice coil. Since such a conventional cone has a plane or slightly arcuate surface, hence, it is liable to be deformed to deteriorate the tone quality thereof after a long-term use.

### SUMMARY OF THE INVENTION

The primary object of the present invention is to provide a cone with better strength for eliminating any possible deformation or tone-quality degradation.

For improvements, the cone is formed polygonally without showing any ridged line that might deteriorate the elasticity of cone's diaphragm and strength.

Compared with a conventional cone of loudspeaker, a polygonally formed cone of the present invention without conspicuous ridged lines is merited in elasticity and long lifetime.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a cross-sectional view of a conventional loudspeaker;

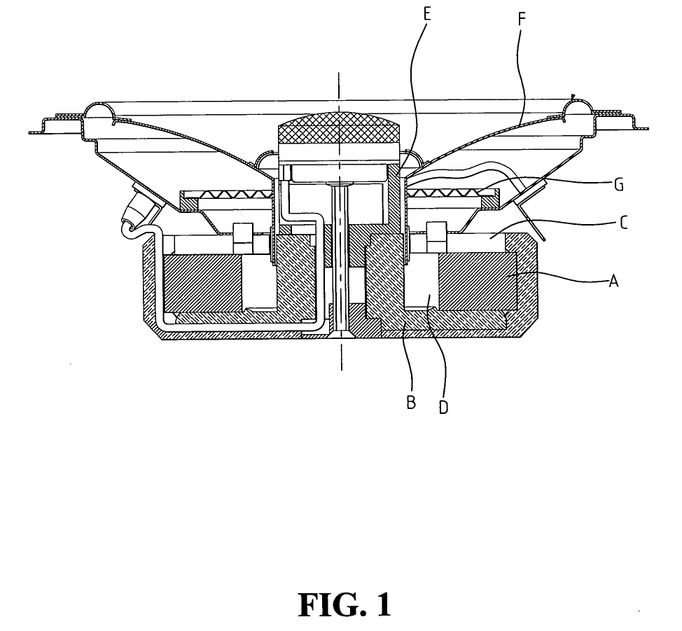

FIG. 2 is a perspective view of a conventional cone;

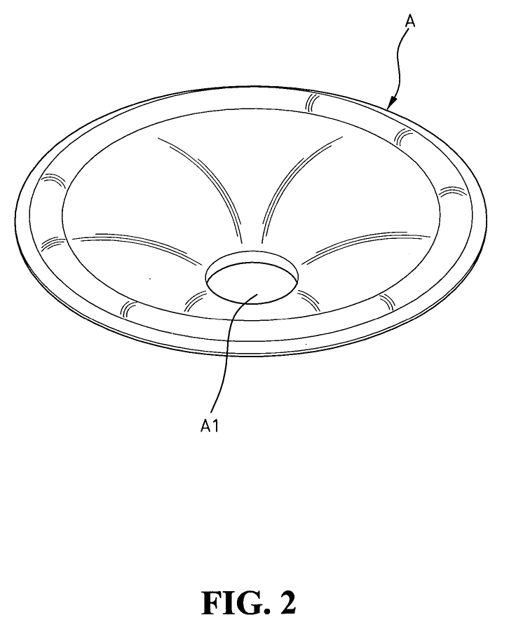

FIG. 3 is a perspective view of a cone constructed in accordance with the present invention; and

FIG. 4 is a plane view of the cone of the present invention.

### DETAILED DESCRIPTION OF THE PREFERRED EMBODIMENT

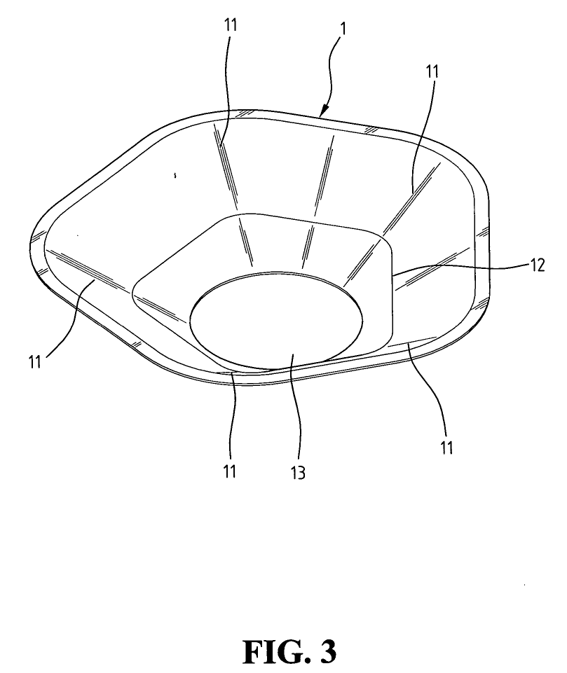

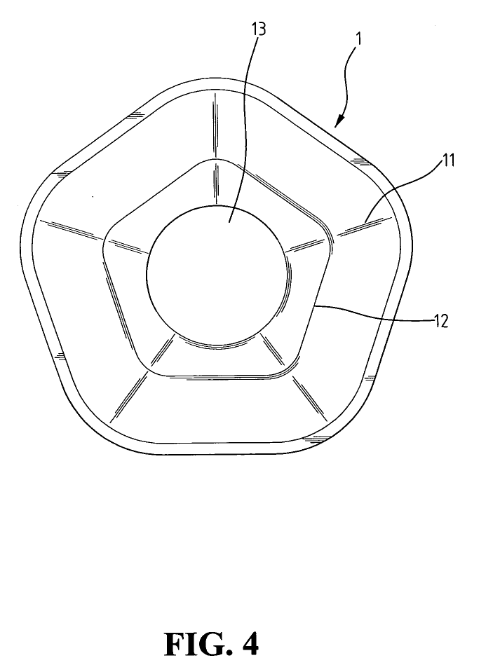

As illustrated in FIGS. 3 and 4, a cone of the present invention is prepared by using a variety of cloth, paper, rubber, and the likes, and laying a tailored polygonal chip of any of the mentioned materials in the space between an upper half and a lower half mold, then, pressing the chip with heat to have a desired cone structure obtained.

It is understood that a cone 1 is formed in a pentagonal cone formed with a central through hole 13 for mounting a voice coil. In building the cone 1, a plurality of turning points 11 is formed radially on a peripheral inner surface of the cone to divide it into multiple planes. Also, at least an annular deflective line 12 is formed on a waistline defined above the through hole 13 for further dividing each plane into two. The key point is that there are no conspicuous ridged lines made and shown in any of the intersections of the turning points 11 and the annular defective line 12, such that it is possible to maintain the elasticity of the cone and prolong the lifetime thereof.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. An angled cone of loudspeaker having a central through hole, in which the cone is provided with a plurality of turning points, arranged in the radial direction to thus form a polygonal cone.

2. The angled cone of loudspeaker as claimed in claim 1, wherein an annular deflective line is formed on a waistline defined between the through hole and the outer rim of the cone for further dividing each plane into some smaller ones.
